(19) United States
(12) Patent Application Publication
(10) Pub. No.: US 2008/0196074 A1
(43) Pub. Date: Aug. 14, 2008

(54) ADVERTISING INFORMATION COLLECTION APPARATUS AND ADVERTISING INFORMATION COLLECTION AND PROVISION APPARATUS, AND ADVERTISING SYSTEM AND METHOD USING THEM

(75) Inventor: Kazuhiro Sakata, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC CORPORATION, Tokyo (JP)

(21) Appl. No.: 12/030,586

(22) Filed: Feb. 13, 2008

(30) Foreign Application Priority Data
Feb. 14, 2007 (JP) 32816/2007
Jan. 9, 2008 (JP) 1740/2008

(51) Int. Cl. H04N 7/173

(52) U.S. Cl. 725/110

(57) ABSTRACT

An advertising information collection apparatus for collecting advertising information includes:
an information acquisition unit which acquires advertiser-related information and audio advertising information from an advertiser via a communication network; and
a storage unit which stores the advertiser-related information and the audio advertising information in association with each other.

This application is based upon and claims the benefit of priority from Japanese patent application No. 2007-032816, filed on Feb. 14, 2007 and Japanese patent application No. 2008-001740, filed on Jan. 9, 2008, the disclosure of which is incorporated herein in its entirety by reference.

### BACKGROUND OF THE INVENTION

1. Field of the Invention

The present invention relates to an advertising information collection apparatus and an advertising information collection and provision apparatus, and an advertising system and method using these, and specifically relates to an advertising information collection system for collecting and providing advertising information using a communication network.

2. Description of the Related Art

With the popularization of the Internet, the provision of advertisements via the Internet is also becoming popular. A related example of such advertising system using the Internet is shown in FIG. 8. The shown system includes an advertisement distribution apparatus 600, a terminal 400, and a network 60 connecting the advertisement distribution apparatus 600 and the terminal 400. An example of the network 60 is the Internet, and examples of the terminal 400 include computer terminals and mobile telephone terminals that are connectable to the Internet.

The advertisement distribution apparatus 600 includes an advertising information storage unit 620 having a function that stores advertising information from advertisers, and an advertising information search and provision unit 610 having a function that searches for and provides advertising information in the advertising information storage unit 620 based on a designation from the terminal 400. This advertisement distribution apparatus 600 is operated and managed by an advertisement distributor, and provides advertising information to a user of the terminal 400 via the network 60.

The proceeding for advertisement distribution processing performed by an advertisement distributor using the advertisement distribution apparatus 600 will be described below in details. Hereinafter, an entity that is the subject of the advertisement, such as a company, an organization, a shop, a personal business and so on, is referred to as an advertiser. First, the advertisement distributor collects advertising information from advertisers, and stores it in the advertising information storage unit 620 in advance.

Here, the advertising information consists of attribute information, such as the name and address of an advertiser, and an advertising content, which is the content of the advertisement. Examples of the attribute information include name, address, telephone number, e-mail address, and business category. The advertising content is provided by the advertiser. The attribute information is provided by the advertiser or acquired from external information source, such as telephone directories or company database.

Next, the advertisement distributor provides advertisements using the advertisement distribution apparatus 600. Hereinafter, an example of an advertisement distribution method using the advertisement distribution apparatus 600 will be described. The advertising information search and provision unit 610 in the advertisement distribution apparatus 600, as shown in FIG. 9, for example, prepares a list of items, as a Web content, each consisting of the name, business category, telephone number of an advertiser in the advertising information storage unit 620 and a link to that advertiser's advertising content, and provides it to the terminal 400 via the network 60.

In the FIG. 9 example, a button labeled as “MORE INFORMATION” corresponds to a link to the advertising content. When a link to a particular advertiser's advertising content is selected via the terminal 400, the advertising information search and provision unit 610 acquires the relevant advertising content in the advertising information storage unit 620, and provides it to the terminal 400 in a format available to the terminal 400 user.

Examples of the related art include those disclosed in Japanese Patent Laid-Open No. 2002-163551, Japanese Patent Laid-Open No. 2002-259819, Japanese Patent Laid-Open No. 2003-283652, Japanese Patent Laid-Open No. 06-338948, and Japanese Patent Laid-Open No. 10-242963.

The related advertisement distribution apparatus 600 shown in FIG. 8 has a problem in that the advertisement distributor has a lot of trouble to acquire the advertising contents from the advertisers. Specific methods for acquiring the advertising contents may include the advertisement distributor personally visiting the advertisers, exchanging documents, orally acquiring them over the telephone. However, these methods require human labor to individually respond to the advertisers.

Although it is possible to save labor by using what is called IT (Information Technology), such as the Web, it cannot be used if the advertiser is not familiar with such technology.

An object of the present invention is to provide an advertising information collection apparatus and an advertising information collection and provision apparatus, which enable an advertisement distributor to collect advertising contents without human labor, and an advertising system and method using them.

Another object of the present invention is to provide an advertising information collection apparatus and an advertising information collection and provision apparatus, which enable an advertiser to provide an advertisement using audio sounds without being conscious of special IT techniques, and an advertising system and method using them.

### SUMMARY

An advertising information collection apparatus according to the present invention includes: an information acquisition unit which acquires advertiser-related information and audio advertising information from an advertiser via a communication network; and a storage unit which stores the advertiser-related information and the audio advertising information in association with each other.

An advertising information collection and provision apparatus according to the present invention includes: an information acquisition unit which acquires advertiser-related information and audio advertising information from an advertiser via a communication network; a storage unit which stores the advertiser-related information and the audio advertising information in association with each other; and an information provision unit which receives a request for advertising information, including a designation of an advertiser-related information, and reads out and sends audio advertising information associated with the designated advertiser-related information.

An advertising system according to the present invention includes: an information acquisition unit which acquires advertiser-related information and audio advertising information from an advertiser via a communication network; a storage unit which stores the advertiser-related information and the audio advertising information in association with each other; and an information provision unit which receives a request for advertising information, including a designation of an advertiser-related information, and reads out and sends audio advertising information associated with the designated advertiser-related information.

An advertising information collection method according to the present invention includes: an information acquisition step of acquiring advertiser-related information and audio advertising information from an advertiser via a communication network; and a storage step of storing the advertiser-related information and the audio advertising information in association with each other.

An advertising information collection and provision method according to the present invention includes: an information acquisition step of acquiring advertiser-related information and audio advertising information from an advertiser via a communication network; a storage step of storing the advertiser-related information and the audio advertising information in association with each other; and an information provision step of receiving a request for advertising information, including a designation of an advertiser-related information, and reading out and sending audio advertising information associated with the designated advertiser-related information.

A program according to the present invention is a program for making a computer execute an operation of an advertising information collection apparatus to collect advertising information, and it includes: processing for acquiring advertiser-related information and audio advertising information from an advertiser via a communication network; and processing for storing the advertiser-related information and the audio advertising information in association with each other.

Another program according to the present invention is a program for making a computer execute an operation of an advertising information collection and provision apparatus to collect advertising information and provide the collected advertising information, and it includes: processing for acquiring advertiser-related information and audio advertising information from an advertiser via a communication network; processing for storing the advertiser-related information and the audio advertising information in association with each other; and processing for receiving a request for advertising information, including a designation of an advertiser-related information, and reading out and sending audio advertising information associated with the designated advertiser-related information.

### BRIEF DESCRIPTION OF THE DRAWINGS

FIG. 1 is a block diagram illustrating a main configuration of an advertisement distribution system according to an exemplary embodiment of the present invention;

FIG. 2 is a diagram illustrating an example of data stored in an audio information storage unit in an information collection apparatus according to an exemplary embodiment of the present invention;

FIG. 3 is a diagram illustrating an example of data stored in an audio information storage unit in an information collection apparatus according to an exemplary embodiment of the present invention;

FIG. 4 is a flowchart indicating the flow of advertising information collection processing performed in an advertisement distribution system according to an exemplary embodiment of the present invention;

FIG. 5 is a diagram illustrating an example of a screen for an advertising service provided by an advertisement distribution system according to an exemplary embodiment of the present invention;

FIG. 6 is a diagram illustrating an example of a screen for an advertising service provided by an advertisement distribution system according to an exemplary embodiment of the present invention;

FIG. 7 is a diagram illustrating an example of a telephone number correspondence table managed in another exemplary embodiment of the present invention;

FIG. 8 is a block diagram illustrating a schematic configuration of a related advertisement distribution system; and

FIG. 9 is a diagram illustrating an example of a screen for an advertising service provided by a related advertisement distribution system.

### DETAILED DESCRIPTION OF THE PREFERRED EMBODIMENTS

Hereinafter, an exemplary embodiment of the present invention will be described in details with reference to the drawings. In this embodiment, advertising contents are provided and managed in the form of audio messages from advertisers. An advertisement distributor obtains a telephone number for advertisement registration, and lays it open to advertisers, and receives audio advertising information provided by advertisers calling the telephone number, and registers it as advertising information.

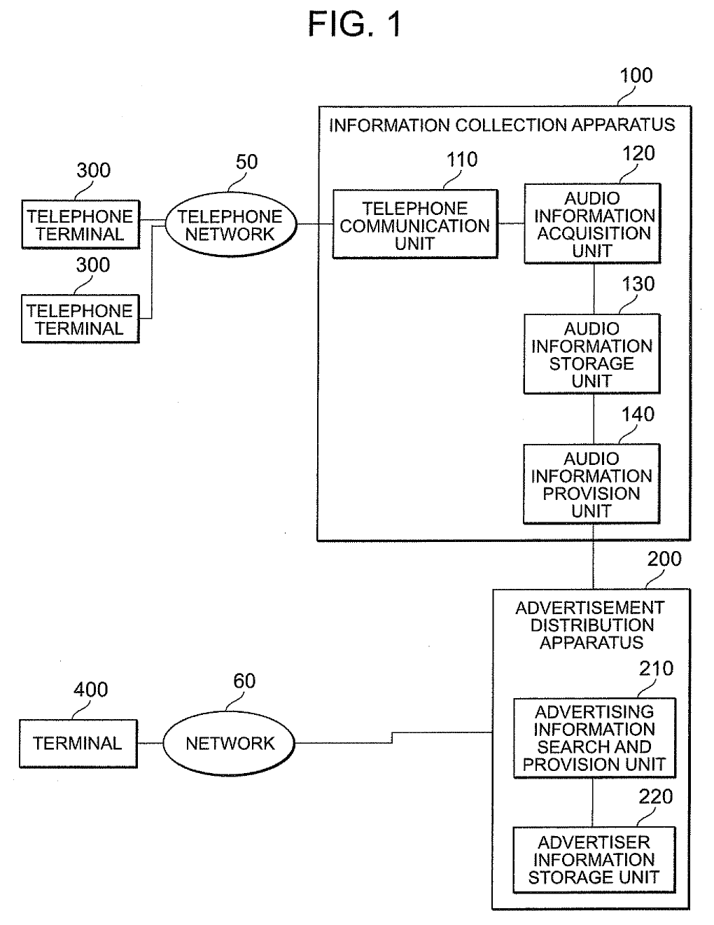

FIG. 1 shows a main configuration of a system according to this embodiment. The system according to this embodiment includes: an information collection apparatus 100; an advertisement distribution apparatus 200; telephone terminals 300; a terminal 400; a telephone network 50 connecting the information collection apparatus 100 and the telephone terminal 300s; and a network 60 connecting the advertisement distribution apparatus 200 and the terminal 400. The telephone network 50 maybe, for example, a public telephone network. The network 60 may be, for example, the Internet.

The terminal 400 has a function that sends/receives data to/from the advertisement distribution apparatus 200 via the network 60. Examples of the terminal 400 include a computer terminal and a mobile telephone terminal. The information collection apparatus 100 includes: a telephone communication unit 110 having a function that provides telephone communication via the telephone network 50 and a function that, when a call is received, acquires the calling telephone number from the telephone network 50; an audio information acquisition unit 120 having a function that acquires audio information from the telephone terminals 300; an audio information storage unit 130 having a function that stores the audio information, and an audio information provision unit 140 having a function that provides the audio information in the audio information storage unit 130 based on an external request.

The advertisement distribution apparatus 200 includes: an advertiser information storage unit 220 having a function that stores attribute information on an advertiser; and an advertising information search and provision unit 210 having a function that searches for and provides advertising information based on a designation from the terminal 400.

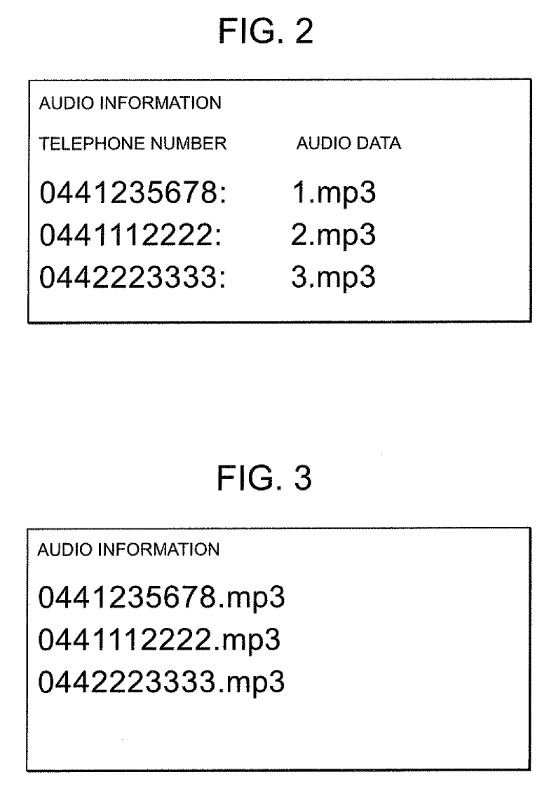

In the audio information storage unit 130, audio advertising data is stored in association with telephone numbers. FIGS. 2 and 3 each illustrate an example of a method for managing audio advertising data in audio information storage unit 130. In the FIG. 2 example, telephone numbers and audio data files are managed as pairs. In the FIG. 3 example, telephone numbers are used for the file names of audio data files. The method for managing audio advertising data in the audio information storage unit 130 may be any method in which the relationship between telephone numbers and audio data is clear.

Next, the processing for distributing an advertisement in the advertisement distribution system according to this embodiment will be described in details. The advertisement distribution processing includes the following two steps: (1) advertising information collection; and (2) advertising information provision. Hereinafter, the respective processing will be described.

### (1) Advertising Information Collection

Advertising information is collected by the information collection apparatus 100. The information collection apparatus 100 is assigned with a telephone number for performing telephone communication via the telephone network 50, and this telephone number is laid open to advertisers. The audio information acquisition unit 120 in the information collection apparatus 100 receives a call to the telephone number from an advertiser, and performs the processing for registering advertising information. The advertiser calls to the telephone number from the telephone terminal 300 to which his/her own telephone number is assigned.

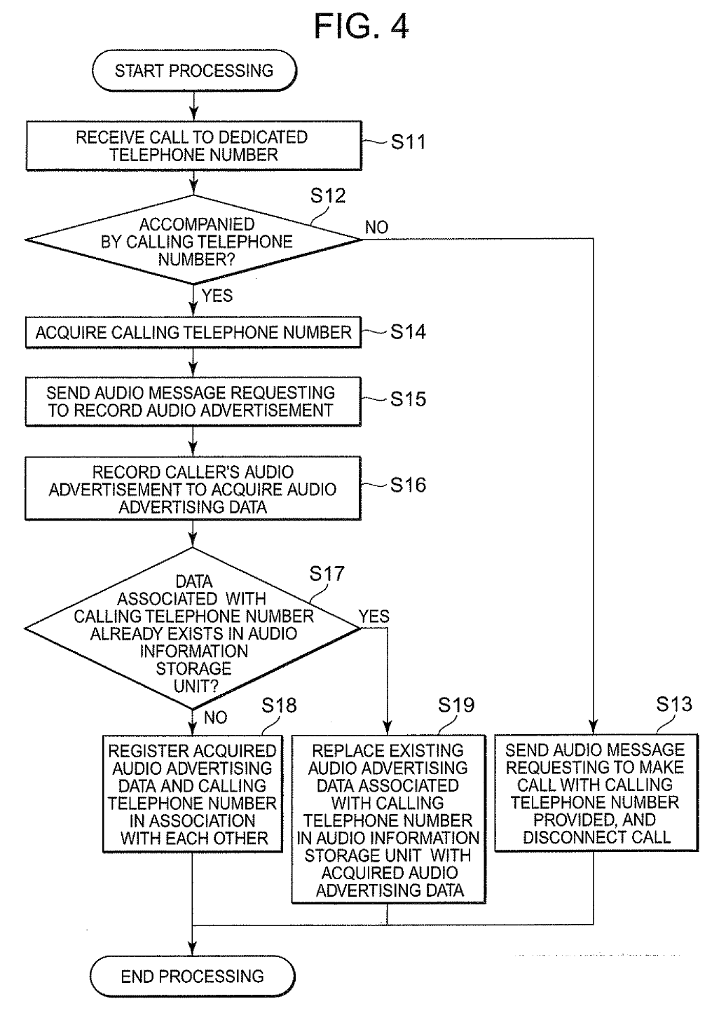

Hereinafter, the details of the processing for registering advertising information in the audio information acquisition unit 120 will be described with reference to FIG. 4. FIG. 4 is a diagram indicating the flow of processing for registering advertising information. First, when an advertiser calls the telephone number for advertising registration, the audio information acquisition unit 120 receives the call via the telephone communication unit 110 (step 11). Next, the audio information acquisition unit 120 confirms whether or not the call received at step S11 is accompanied by the calling telephone number (step S12), and if it is not, the audio information acquisition unit 120 sends to the caller via the telephone communication unit 110 an audio message requesting to make a call with the calling telephone number provided, and disconnects the call (step S13) and then ends the processing.

If the call received at step S11 is accompanied by the calling telephone number, the audio information acquisition unit 120 acquires, as an example of calling telephone number, the telephone number of the caller who has made the call at step S11 from the telephone communication unit 110 (step S14). And then, the audio information acquisition unit 120 sends via the telephone communication unit 110 a message requesting the caller to record audio advertisement (step S15). An example of the requesting message may be: “This is the audio advertisement registration center. Please record your audio advertisement within one minute after the tone.”

Subsequently, the audio information acquisition unit 120 records the audio advertisement from the caller to acquire audio advertising data (step S16). Next, the audio information acquisition unit 120, referring to the audio information storage unit 130, confirms whether or not audio advertising data associated with the calling telephone number acquired at step S14 is stored in the audio information storage unit 130 (step S17). If it is not, the audio information acquisition unit 120 stores a pair of the calling telephone number acquired at step S14 and the audio advertising data acquired at step S16 in the audio information storage unit 130 (step S18), and ends the processing. If it is, the audio information acquisition unit 120 replaces existing audio advertising data associated with the calling telephone number acquired at step S14 with the audio advertising data obtained at step S16 (step S19), and ends the processing.

With the above-described processing, the audio information acquisition unit 120 stores a pair of audio advertising data and the calling telephone number. In the series of steps in the processing, the response to the call from the advertiser and the audio data registration are automatically performed by the information collection apparatus 100, not requiring human labor on the advertisement distribution side.

In the above example, although the information collection apparatus 100 is provided with advertising information from advertisers by telephone communication via the telephone network 50, the present invention is not limited to this case. For example, advertising information can also be provided by communication via a network, such as VOIP (Voice Over Internet Protocol), that enables an advertiser to provide using audio advertisement without being conscious of special IT techniques.

Also, in the above example, although the calling telephone number of the terminal 400 is acquired as an example of information related to an advertiser (advertiser-related information), the present invention is not limited to this case. For example, information unique to an advertiser, such as IP address, can be acquired as advertiser-related information instead of the calling telephone number. If advertiser-related information other than the calling telephone number, such as IP address, is acquired, the advertiser-related information may be converted to a telephone number. As a result, various advertiser-related information can be collectively managed with a telephone number.

In the above examples, it audio advertising data associated with the calling telephone number acquired at step S14 is already stored in the audio information storage, the audio information acquisition unit 120 replaces the existing audio advertising data with the audio advertising data obtained at step S16 (step S19). However, the present invention is not limited to this case. For example, the audio information acquisition unit 120 may store the audio advertising data obtained at step S16 in addition to the existing audio advertising data.

### (2) Advertising Information Provision

Advertising information is provided by the advertisement distribution apparatus 200. The audio information provision unit 140 in the information collection apparatus 100 has a function that, upon receipt of a telephone number designation from the advertisement distribution apparatus 200, indicates whether or not audio advertising data associated with the telephone number exists, and a function that, upon receipt of a telephone number designation, sends audio advertising data associated with the telephone number.

More specifically, the audio information provision unit 140, upon receipt of a request for confirming whether or not audio information exists, including a telephone number designation, searches for audio information associated with the telephone number in the audio information storage unit 130, and indicates whether or not the associated audio advertising data exists. Also, the audio information provision unit 140, upon receipt of an audio information request including a telephone number designation, searches for audio information associated with the telephone number in the audio information storage unit 130, and sends the associated audio advertising data.

The advertisement distribution apparatus 200 provides an advertising service with the terminal 400 user via the network 60, using audio advertising data provided from the information collection apparatus 100. Hereinafter, a specific method of providing an advertising service will be described.

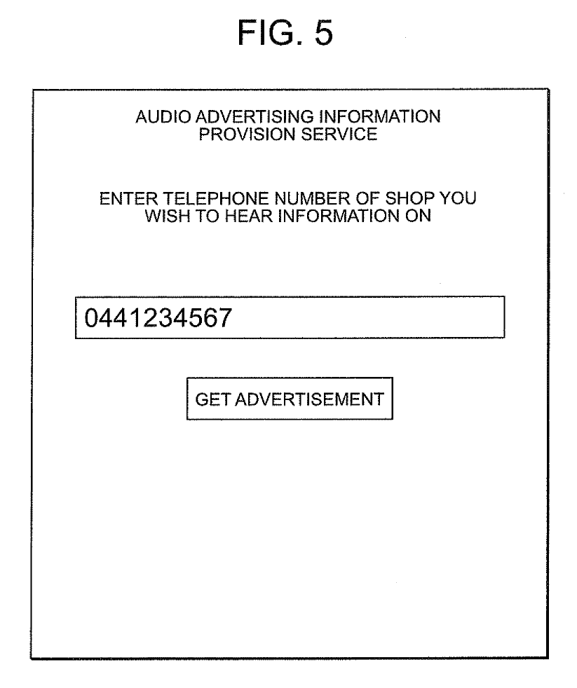

An example of the provision method is a method in which the advertisement distribution apparatus 200, upon receipt of a telephone number designation from a user, provides advertising data for the relevant advertiser. The advertising information search and provision unit 210 provides the terminal 400 with a content shown in FIG. 5 for receiving a telephone number designation, for example. Then, the advertisement distribution apparatus 200, upon receipt of a telephone number designation from a user, requests the information collection apparatus 100 to send audio advertising data associated with the designated telephone number, and thereby acquires the audio advertising data, and sends it to the terminal 400.

As a result, the terminal 400 user can acquire audio advertising data for an advertiser corresponding to a telephone number by designating the telephone number. If the terminal 400 has a telephone function, the advertisement distribution apparatus 200 may send the audio advertising data by a method in which it acquires a telephone number for the terminal 400 from the user in advance, and calls the terminal 400 and replays the audio advertising data.

As is clear from above description,the exemplary embodiment of the present invention enables an advertisement distributor to collect advertising contents without human labor, and enables an advertiser to provide an advertisement using audio sounds without being conscious of special IT techniques. Furthermore, it eliminates the need for an environment that allows connection to the IP (Internet Protocol) network if an existing telephone network is used.

Another example of the provision method is a method in which various attribute information and a telephone number for an advertiser are stored in advance in the advertiser information storage unit 220 of the advertisement distribution apparatus 200, and upon receipt of attribute information from a user, the attribute information being capable of identifying the advertiser, advertising data for the relevant advertiser is provided. Examples of the advertiser attribute information include name, business category, address area and address. The advertising information search and provision unit 210 provides a content including functions that allow the terminal 400 user to search for and select an advertiser. More specifically, the functions that allow the search and selection of an advertiser may include functions, such as keyword search, search refinement by giving conditions, and list display.

Upon a specific advertiser being selected by the terminal 400 user based on these functions, the advertising information search and provision unit 210 searches for a telephone number associated with the advertiser designated by the advertiser information storage unit 220, and then requests information collection apparatus 100 to send audio advertising data associated with the telephone number, and thereby acquires the audio advertising data and sends it to the terminal 400. Thus, the terminal 400 user can acquire the audio advertising data by designating an advertiser.

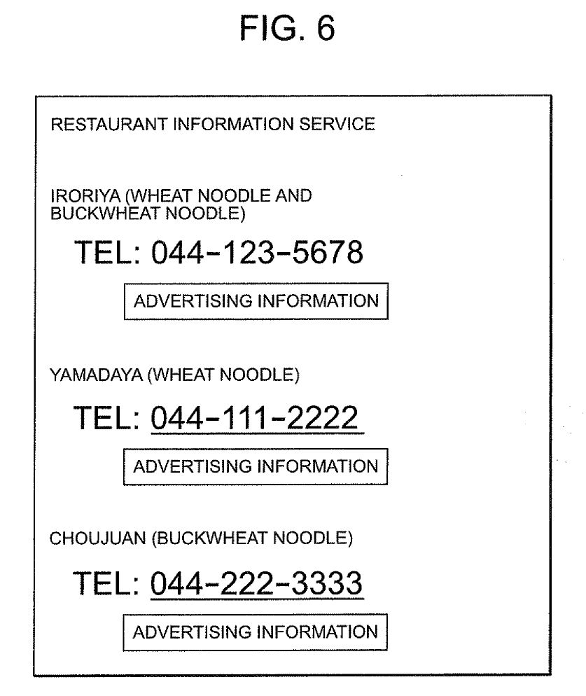

Another example of the provision method is a method in which the advertisement distribution apparatus 200 provides the terminal 400 with advertising data by attaching a link to the advertising data to some kind of existing content. For example, character strings indicating telephone numbers are searched for in a Web content, and each telephone number character string is provided with a link for requesting advertising data associated with the telephone number. An example of a Web content with links added is shown in FIG. 6. In this example, three telephone numbers are included in the content, and a link titled “ADVERTISING INFORMATION” is provided to each telephone number.

Upon one of the links being selected by the terminal 400 user, the advertising information search and provision unit 210 requests the information collection apparatus 100 to send audio advertising data associated with the telephone number provided with the link, and thereby acquires the audio advertising data, and sends it to the terminal 400. Thus, the terminal 400 user can acquire audio advertising data for the relevant advertiser by designating a link in the content.

In this provision method, as well, it is possible that various attribute information for an advertiser is stored in the advertiser information storage unit 220, and that a link to audio advertising data is provided to advertiser information other than the telephone number (e.g., advertiser name) in an existing content.

Several examples have been described above, and in every example, the advertisement distribution apparatus 200 can acquire an advertising content from the information collection apparatus 100, so it is unnecessary for an advertisement distributor operating the advertisement distribution apparatus 200 to collect contents with human labor.

In the above examples, the advertisement distribution apparatus 200 provides the terminal 400 with information in the form of a Web content, but the content form is not limited to a Web content, and it may be any form that the terminal 400 can recognize.

The above-described advertisement distribution methods are only examples, and there may be the case where the advertisement distribution apparatus 200 provides a user interface for advertisement search, or provides an advertising content after integrating it with other contents, for example.

As described above, in this embodiment, collection of advertising contents is automatically conducted by registering them with telephone calls from advertisers, and accordingly, on the information collection apparatus 100 operation side, once a telephone number is obtained and laid open, advertising information will be automatically collected without human work. Furthermore, since a telephone network, which is widely popular, is used, even an advertiser having no IT techniques can easily register an advertisement. Also, it is possible to prevent a third party's alternation of advertising information, as a result of identifying an advertiser using his/her calling telephone number, which is difficult to feign. As described above, this embodiment makes it possible for an advertisement distributor to easily collect advertising contents.

Next, another exemplary embodiment of the present invention will be described. In the above-described embodiment, the audio information provision unit 140 sends audio data as it is, in response to a request from the advertisement distribution apparatus 200. However, it is also possible that the audio information provision unit 140 sends audio data after performing some kind of conversion processing on it. More specifically, audio data may be converted to text data by voice recognition processing. As a result, the information collection apparatus 100 can provide the advertisement distribution apparatus 200 with advertising data in a form other than audio data.

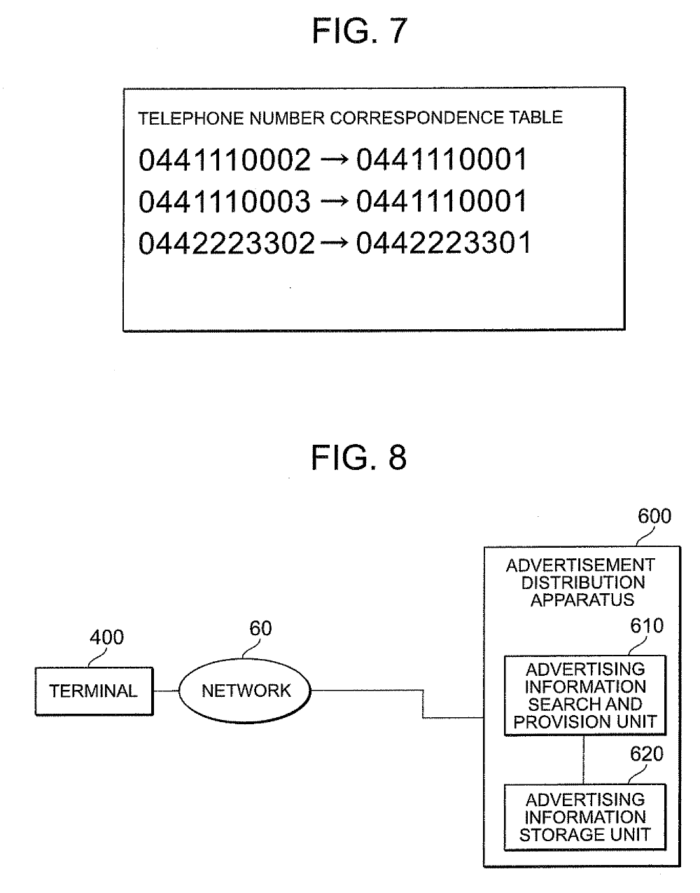

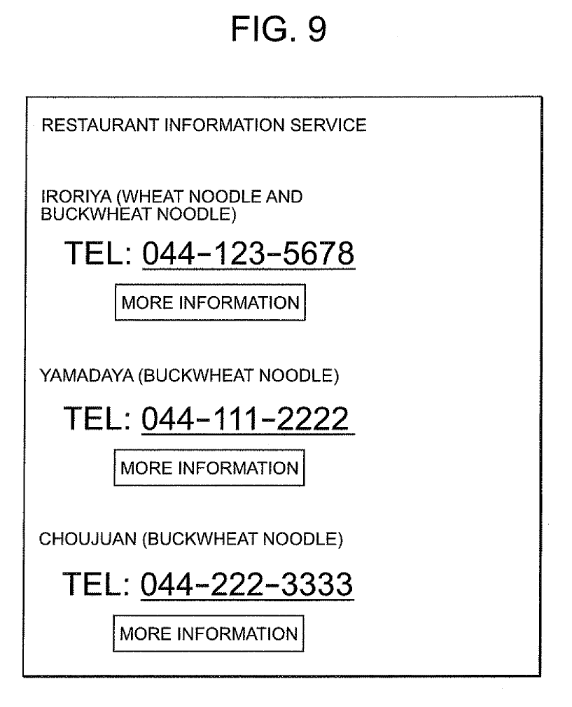

In the above-described embodiment, telephone numbers and audio data are stored one by one in the audio information storage unit 130. However, one audio data may be associated with a plurality of telephone numbers. More specifically, for example, it is possible that a telephone number correspondence table is provided in the information collection apparatus 100 as shown in the FIG. 7 example, and that, upon the processing at step S12 in FIG. 4, or upon receipt of a request from the advertisement distribution apparatus 200, processing is executed after converting the telephone number to another telephone number.

In this example, the processing is performed after converting the telephone numbers “0441110002” and “0441110003” to “0441110001”, and converting the telephone number “0442223302” to “0442223301”. This makes it possible to associate common audio data with “0441110001”, “0441110002” and “0441110003,” and also to associate common audio data with “0442223301” and “0442223302”. Such a mechanism makes it possible to, even if an advertiser has a plurality of telephone numbers, associate the telephone numbers with the same audio data.

An organization, such as a company, can provide various services using the information collection apparatus using the above embodiment. For example, it is possible that an organization A possesses an information collection apparatus, and conducts a business in which it collects advertising contents, provides these contents to another organization B providing an information service, and receives compensation for that provision.

It is apparent that the operation in each of the above embodiments can be arranged so that the procedure of that operation is stored in advance in a recording medium such as ROM, and is executed by making a computer read it.

As is clear from above description, the exemplary embodiment of the present invention enables an advertisement distributor to collect advertising contents without human labor, and enables an advertiser to provide an advertisement using audio sounds without being conscious of special IT techniques. Furthermore, it eliminates the need for an environment that allows connection to the IP (Internet Protocol) network if an existing telephone network is used.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An advertising information collection apparatus for collecting advertising information, comprising:
an information acquisition unit which acquires advertiser-related information and audio advertising information from an advertiser via a communication network; and
a storage unit which stores the advertiser-related information and the audio advertising information in association with each other.

2. The advertising information collection apparatus according to claim 1, wherein the communication network is a telephone network.

3. The advertising information collection apparatus according to claim 1 or 2, wherein the advertiser-related information is a calling telephone number of the advertiser.

4. The advertising information collection apparatus according to any of claims 1 to 3, wherein the information acquisition unit acquires the audio advertising information from the advertiser by recording the audio advertising information.

5. An advertising information collection and provision apparatus for collecting advertising information and providing the collected advertising information, comprising:
an information acquisition unit which acquires advertiser-related information and audio advertising information from an advertiser via a communication network;
a storage unit which stores the advertiser-related information and the audio advertising information in association with each other; and
an information provision unit which receives a request for advertising information, including a designation of an advertiser-related information, and reads out and sends audio advertising information associated with the designated advertiser-related information.

6. The advertising information collection and provision apparatus according to claim 5, wherein the communication network is a telephone network.

7. The advertising information collection apparatus according to claim 5 or 6, wherein the information acquisition unit acquires the audio advertising information from the advertiser by recording the audio advertising information.

8. The advertising information collection and provision apparatus according to any of claims 5 to 7, wherein the advertiser-related information is a calling telephone number of the advertiser.

9. The advertising information collection and provision apparatus according to any of claims 5 to 7, wherein when the advertiser-related information is information other than a calling telephone number, the information providing means converts the advertiser-related information to a telephone number.

10. The advertising information collection and provision apparatus according to any of claims 5 to 9, wherein the information provision unit further includes a conversion unit which converts the audio advertising information to information in another form.

11. The advertising information collection and provision apparatus according to claim 10, wherein the information in another form is text data.

12. An advertising system for collecting advertising information and providing the collected advertising information, comprising:
an information acquisition unit which acquires advertiser-related information and audio advertising information from an advertiser via a communication network;
a storage unit which stores the advertiser-related information and the audio advertising information in association with each other; and
an information provision unit which receives a request for advertising information, including a designation of an advertiser-related information, and reads out and sends audio advertising information associated with the designated advertiser-related information.

13. The advertising system according to claim 12, wherein the communication network is a telephone network.

14. The advertising system according to claim 12 or 13, wherein the information acquisition unit acquires the audio advertising information from the advertiser by recording the audio advertising information.

15. The advertising system according to any of claims 12 to 14, wherein the advertiser-related information is a calling telephone number of the advertiser.

16. The advertising system according to any of claims 12 to 14, wherein when the advertiser-related information is information other than a calling telephone number, the information provision unit converts the advertiser-related information to a telephone number.

17. The advertising system according to any of claims 12 to 16, wherein the information provision unit further includes a conversion unit which converts the audio advertising information to information in another form.

18. The advertising system according to claim 17, wherein the information in another form is text data.

19. An advertising information collection method for collecting advertising information, comprising:
an information acquisition step of acquiring advertiser-related information and audio advertising information from an advertiser via a communication network; and
a storage step of storing the advertiser-related information and the audio advertising information in association with each other.

20. The advertising information collection method according to claim 19, wherein the communication network is a telephone network.

21. The advertising information collection method according to claim 19 or 20, wherein the advertiser-related information is a calling telephone number of the advertiser.

22. The advertising information collection method according to any of claims 19 to 21, wherein in the information acquisition step, the audio advertising information from the advertiser is acquired by recording the audio advertising information.

23. An advertising information collection and provision method for collecting advertising information and providing the collected advertising information, comprising:
an information acquisition step of acquiring advertiser-related information and audio advertising information from an advertiser via a communication network;
a storage step of storing the advertiser-related information and the audio advertising information in association with each other; and
an information provision step of receiving a request for advertising information, including a designation of an advertiser-related information, and reading out and sending audio advertising information associated with the designated advertiser-related information.

24. The advertising information collection and provision method according to claim 23, wherein the communication network is a telephone network.

25. The advertising information collection and provision method according to claim 23 or 24, wherein in the information acquisition step, the audio advertising information from the advertiser is acquired by recording the audio advertising information.

26. The advertising information collection and provision method according to any of claims 23 to 25, wherein the advertiser-related information is a calling telephone number of the advertiser.

27. The advertising information collection and provision method according to any of claims 23 to 25, wherein in the information provision step, when the advertiser-related information is information other than a calling telephone number, the advertiser-related information is converted to a telephone number.

28. The advertising information collection and provision method according to any of claims 23 to 27, wherein the information provision step further includes a step of converting the audio advertising information to information in another form.

29. The advertising information collection and provision method according to claim 28, wherein the information in another form is text data.

30. A program for making a computer execute an operation of an advertising information collection apparatus to collect advertising information, the program comprising:
processing for acquiring advertiser-related information and audio advertising information from an advertiser via a communication network; and
processing for storing the advertiser-related information and the audio advertising information in association with each other.

31. A program for making a computer execute an operation of an advertising information collection and provision apparatus to collect advertising information and provide the collected advertising information, the program comprising:
processing for acquiring advertiser-related information and audio advertising information from an advertiser via a communication network;
processing for storing the advertiser-related information and the audio advertising information in association with each other; and
processing for receiving a request for advertising information, including a designation of an advertiser-related information, and reading out and sending audio advertising information associated with the designated advertiser-related information.
